(19) United States
(12) Patent Application Publication
(10) Pub. No.: US 2008/0239098 A1
(43) Pub. Date: Oct. 2, 2008

(54) DIGITAL CAMERA AND CONTROL METHOD THEREOF

(76) Inventor: Takeshi SUZUKI, Tokyo (JP)

Correspondence Address: John C. Pokotylo;STRAUB & POKOTYLO, Bldg.B, 2nd Floor, 620 Tinton Avenue, Tinton Falls, NJ, 07724-3260, US

(21) Appl. No.: 12/052,298

(22) Filed: Mar. 20, 2008

(30) Foreign Application Priority Data
Mar. 29, 2007 (JP) 2007-089013

(51) Int. Cl. H04N 5/76

(52) U.S. Cl. 348/231.99

(57) ABSTRACT

In the present invention, a second CPU is configured to include an image recognition function part, an image compression/expansion part as a reduced image generation part, a WUSB connection authentication Host image generation function as a list generation part, and a recording medium access part as an image record controlling part. The WUSB connection authentication Host image generation function is a function of generating a WUSB connection authentication Host image, which is a selection list including Host photographed image relating to WUSB connectable Hosts and equipment specification information for specifying the Hosts; and is adapted to allow easy selection of a desired connection destination from a plurality of connection destinations.

### CROSS REFERENCE TO RELATED APPLICATION

This application claims benefit of Japanese Patent Application No. 2007-089013 filed in Japan on Mar. 29, 2007, the contents of which are incorporated by this reference.

### BACKGROUND OF THE INVENTION

1. Field of the Invention

The present invention relates to a digital camera and a control method thereof, particularly to a digital camera including a wireless communication function for performing wireless communication with external apparatuses, and a control method thereof.

2. Description of the Related Art

Conventionally, it is essential for wireless equipment such as a digital camera, which includes a wireless communication function to perform wireless communication with an external apparatus, to perform inter-equipment authentication before initiating wireless communication with the external apparatus.

Further, the external apparatus, which can be a counterpart to and from which one specific wireless equipment (for example, a digital camera) can transmit/receive data using a wireless communication function, may not always be limited to one specific apparatus, but may be multiple apparatuses. Therefore the aforementioned authentication needs to be separately performed for each external apparatus which becomes the target for the wireless communication.

In such a case, when performing wireless communication with an external apparatus, it is not effective to perform complicated authentication operation every time when the target apparatus changes. Accordingly, some conventional wireless equipment are configured such that for a target apparatus with which communication has been established through authentication operation, the authentication information as the communication setting information for that wireless connection is stored as registered information in a non-volatile memory or the like provided within the wireless equipment.

Such configuration makes it possible to establish wireless communication simply and promptly even when there are multiple target equipment with which wireless communication is to be performed by appropriately reading out and utilizing authentication information conforming to the target equipment out of a plurality of registered information from the storage part within the equipment.

When a wireless technology is used, it becomes important to simplify the kind of equipment of the connection destination; heretofore, a listing of connection destinations is created in which the names thereof are denoted by characters, as shown, for example, in Japanese Patent Publication Laid-Open No. 2001-197150.

Further, as shown for example in Japanese Patent Publication Laid-Open No. 2006-067231, it is proposed to perform the designation of connection destination based on specific information of the communication counterpart. And Japanese Patent Publication Laid-Open No. 2006-067231 discloses that selection information or the like on a desired connection destination is pre-registered so that connection with other than that connection destination is automatically avoided.

### SUMMARY OF THE INVENTION

A digital camera according to a first aspect of the present invention is configured to include:

a photographing part for photographing an object;

an image storage control part for performing the control to cause an image memory to store an image photographed at the photographing part as a photographed image;

an information display part for displaying various information including the photographed image on a display;

a communication part for performing the transmission/reception of information to and from an external apparatus by wireless communication;

a communication setting information generation part for generating communication setting information for establishing wireless communication with the external apparatus;

a communication information storage part for storing the communication setting information, equipment specification information for specifying the external apparatus with which the communication part communicates, and an index image of the external apparatus based on the photographed image of the external apparatus so as to be associated with each other, in a communication information memory;

a list generation part for generating a selection list for listing and displaying the index image of the external apparatus stored in the communication information memory, or combined information including the index image of the external apparatus and the equipment specification information of the external apparatus, on the display;

a selection part for selecting an external apparatus, with which the communication part is to establish communication, out of the selection list displayed on the display; and

a communication establishment part for establishing communication with the external apparatus selected at the selection part based on the communication setting information of the external apparatus selected at the selection part.

Other features and merits of the present invention will become sufficiently apparent by the following description.

### BRIEF DESCRIPTION OF THE DRAWINGS

FIGS. 1 to 9 relate to an embodiment 1 of the present invention, wherein FIG. 1 is a block diagram to show the configuration of a digital camera; FIG. 2 is a functional block diagram to show the configuration of a first CPU of FIG. 1; FIG. 3 is a functional block diagram to show the configuration of a second CPU of FIG. 1; FIG. 4 shows the configuration of data retained in an EEPROM of FIG. 1; FIG. 5 is a flowchart to show the flow of registration processing of an external apparatus (Host) which is a connection destination and compatible with the WUSB (Wireless Universal Serial Bus) standard, by the first CPU of FIG. 1; FIG. 6 is a first view to show a screen deployed by the processing of FIG. 5; FIG. 7 is a second view to show a screen deployed by the processing of FIG. 5; FIG. 8 is a flowchart to show the flow of the authentication processing during WUSB connection by the first CPU of FIG. 1; and FIG. 9 shows a screen deployed by the processing of FIG. 8.

FIG. 10 and FIG. 11 relate to an embodiment 2 of the present invention, wherein FIG. 10 is a flowchart to show the flow of registration processing of a WUSB compatible Host by the first CPU; and FIG. 11 shows a screen deployed by the processing of FIG. 10.

FIG. 12 and FIG. 13 relate to an embodiment 3 of the present invention, wherein FIG. 12 is a flowchart to show the authentication processing during WUSB connection by the first CPU; and FIG. 13 is a flow chart to show the flow of Host authentication processing by a mathematical model of FIG. 12.

FIG. 14 to FIG. 17 relate to an embodiment 4 of the present invention, wherein FIG. 14 is a flowchart to show the flow of the authentication processing during WUSB connection by the first CPU; FIG. 15 is a flowchart to show the flow of the Host image recognition processing of FIG. 14; FIG. 16 shows a screen deployed in the processing of FIG. 15; and FIG. 17 shows a modification of the screen of FIG. 16.

### DETAILED DESCRIPTION OF THE PREFERRED EMBODIMENTS

### Embodiment 1

A related art according to Japanese Patent Laid-Open No. 2001-197150 has a problem in that discrimination of connection destinations through the name denotation by characters becomes difficult when the number of connection destinations increase.

Further, another related art according to Japanese Patent Laid-Open No. 2006-067231 has a problem in that initial condition setting is difficult, and in that such as when a change of connection destination is desired depending on situations, the connection destination needs to be selected after all from a connection list and, the discrimination of the connection destination at this time is difficult as in the case of Japanese Patent Laid-Open No. 2001-197150.

Accordingly, in a present embodiment, a digital camera which enables to easily select a desired connection destination out of a plurality of connection destinations, and a control method thereof will be described.

The digital camera of the present embodiment is a wireless device by which an object image formed by a lens is received and photoelectrically converted thereby being recorded as electronic image data, and which has a wireless communication function to perform wireless communication with external apparatuses (for example, personal computers, external storage devices or other digital cameras).

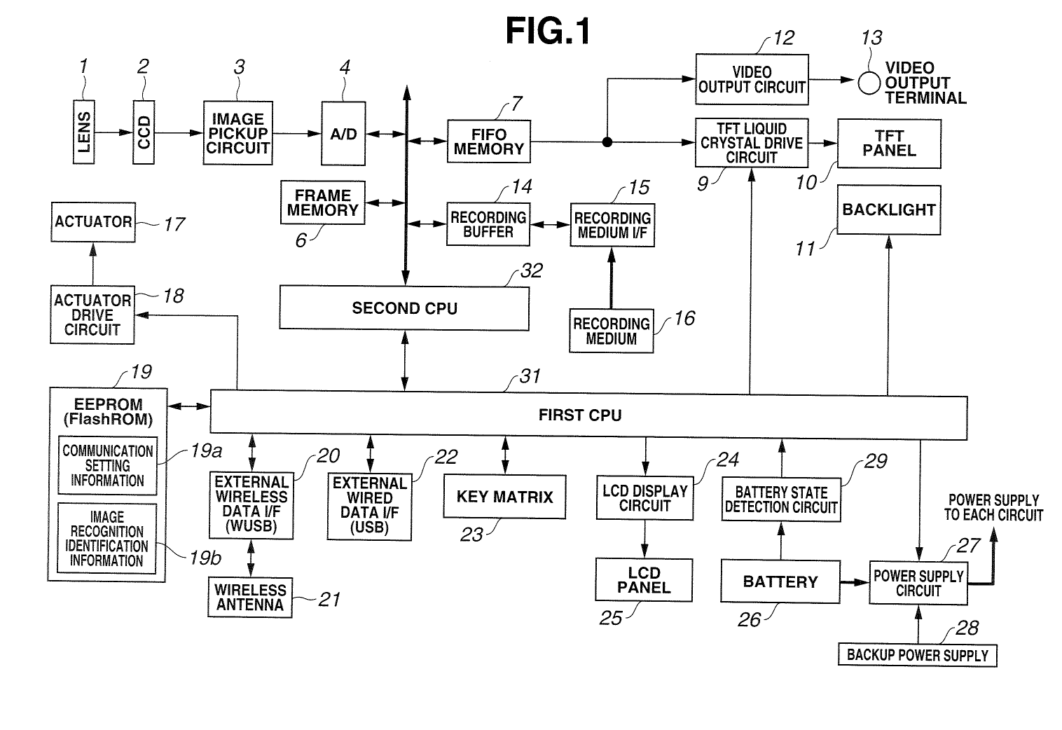

The digital camera is, as shown in FIG. 1, primarily made up of: a lens 1; an image pickup device as a photographing part, for example, a CCD 2 (may be C-MOS device); an image pickup circuit 3; an A/D converter (simply denoted as “A/D” in FIG. 1) 4; a frame memory 6; an FIFO (First-In and First-Out) memory 7; a TFT liquid crystal drive circuit 9; a TFT panel 10 as a display part; a backlight unit 11; a video output circuit 12; a video output terminal 13; a recording buffer 14; a recording medium interface (recording medium I/F) 15; a recording medium 16 which is an image memory as an image recording part; an actuator 17; an actuator drive circuit 18; an external wired data interface (external wired I/F) 22; a key matrix 23 as a selection part; an LCD display circuit 24; an LCD panel 25; a battery 26; a power supply circuit 27; a backup power supply 28; a battery state detection circuit 29; a first CPU 31; a second CPU 32 as an information display control part; EEPROM 19 which is a storage part for various data as a communication setting information storage part; an external wireless data interface (I/F) 20 as a communication part; a wireless antenna 21; and the like.

Further, although the selection part is supposed to be made up of the key matrix 23, the configuration is not limited thereto, but may be such that a touch panel function (not shown) is provided in the TFT panel 10 so that the touch panel function serves as the selection part.

The lens 1 is provided to form an optical object image such that an image thereof is formed on the light receiving surface of the image pickup device 2.

The image pickup device 2 is a device which receives an optical object image formed by the lens 1 and performs photoelectric conversion thereof to output an electrical image signal. For the image pickup device 2, image pickup devices capable of high speed reading, for example, a CCD (Charge Coupled Device), a CMOS (Complementary Metal Oxide Semiconductor), or other various types of image pickup devices can be applied.

The image pickup circuit 3 is an electronic circuit which receives an output signal from the image pickup device 2 and performs various analog signal processing on the image signal.

The A/D converter 4 is a circuit by which an analog format image signal outputted from the image pickup circuit 3 is received and is converted into a digital format image signal.

Further, in the digital camera of the present embodiment, the above described lens 1, the image pickup device 2, the image pickup circuit 3, the A/D converter 4, and the others make up the principal part of the photographing part for photographing an object.

The second CPU 32 has a function of receiving a digital format image signal outputted from the A/D converter 4 and performing various kinds of digital signal processing.

The frame memory 6 is a temporary storage part for receiving an image signal processed by the second CPU 32 and temporarily storing the processed image signal, various data relating to the image signal, and the like. For the frame memory 6, for example, a semiconductor device such as a SDRAM is applied.

The FIFO memory 7 is a memory which is provided to temporarily store an image signal when the image signal is outputted to various display apparatuses.

The TFT liquid crystal drive circuit 9 is a circuit which is provided to receive an image signal outputted from the FIFO memory 7 and control the TFT panel 10.

The TFT panel 10 is a display part for displaying an image based on the image signal, various information in the digital camera, and the like through the control by the TFT liquid crystal drive circuit 9, and one which is capable of displaying color is used.

The backlight unit 11 is provided in the back of the TFT panel 10 and is intended to illuminate the TFT panel 10 from back side.

Moreover, in the digital camera of the present embodiment, the above described TFT liquid crystal drive circuit 9, the TFT panel 10, the backlight unit 11 and the like make up the principal part of the display part, which displays an object image photographed by the photographing part, as an electronic image.

The video output circuit 12 is a circuit by which an image signal from the FIFO memory 7 is received, converted into, for example, a video signal of the NTSC format, and outputted via the video output terminal 13 to an external display apparatus or the like connected to the video output terminal 13.

The video output terminal 13 is a connection terminal for connecting a signal line such as a video cable for electrically connecting the present digital camera with an external display apparatus or the like.

The recording buffer 14 is a buffer (temporal save area) which is used when recording an image signal and the like temporarily stored in the frame memory 6, in the recording medium 16 as image data, or when reading image data from the recording medium 16 and temporarily storing image data in the frame memory 6, or in other situation.

The recording medium I/F 15 is intended for controlling the recording of image data and the like to the recording medium 16 and the reading of image data and the like from the recording medium 16.

The recording medium 16 is a non-volatile recording medium for storing image data and various other data, for example, a memory card of a sheet form or a card form, and the like. The recording medium 16 includes those of various forms such as a form to be detachable from equipment such as a digital camera, a form to be fixed to an electric circuit inside equipment such as a digital camera, and so on; and any form can be applied to the digital camera of the present embodiment.

Moreover, the digital camera of the present embodiment utilizes a recording medium 16 of a form in which the recording medium 16 is detachably arranged with respect to the camera.

The above described recording buffer 14, the recording medium I/F 15, and so on make up the principal part of an image storage part for storing image signals relating to the image photographed at the above described photographing part and associated data thereof in the recording medium 16 as data of a predetermined format.

The actuator 17 is a driving source for driving the lens 1 to perform focusing operation or zooming operation.

The actuator drive circuit 18 is a circuit for controlling the driving of the actuator 17 based on the control of the first CPU 31.

The external wired data interface (external wired data I/F) 22 is a connection portion (interface) which is intended for performing the transmission and reception of data and the like between the present digital camera and an external apparatus through a connection cable or the like, and to which, for example, those conforming to the USB (Universal Serial Bus) standard, the IEEE 1394 standard, and the like are applied.

The external wired data interface (external wired data I/F) 22 and the connection cable (not shown) make up the principal part of the second communication part which transmits and receives information to and from an external apparatus through wired communication.

The term “key matrix 23” is used as a generic name of the operation input part provided in the digital camera of the present embodiment, including various operation switches, operation buttons, and the like. That is, specific configurations of the key matrix 23 include, for example, a power supply button for turning on or off the power supply of the digital camera, a release button for starting the photographing operation, a four-way selection key (also called as a cross key) for performing the selection/setting on a menu screen and the like, various operation members and switch members for generating a predetermined instruction signal linked with each of the operation members, and electric circuits for transferring the instruction signal from each switch member. The signal generated by an operation of each operation member of the key matrix 23 is adapted to be outputted to the first CPU 31.

The LCD display circuit 24 is a circuit for controlling the LCD panel 25 based on the control of the first CPU 31, to make the LCD panel display various information.

The LCD panel 25 is a information display member which is made up of, for example, a monochrome LCD and the like, and which displays various setting information set in the digital camera: for example, operation mode information such as a photographing mode, information of the number of images which can be recorded in the recording medium 16, and information relating to exposure such as a shutter speed and a f number.

The battery 26 is a main power supply (main) in the digital camera.

The backup power supply 28 is a secondary (sub) power supply which is provided to constantly supply power to an internal memory, an internal clock, and the like of the digital camera, and which is intended to retain information such as various setting values in the present digital camera, date and time information, and the like and enable to continuously display the date using the above described LCD panel 25 or the like.

The power supply circuit 27 is a circuit for performing the control to receive power from the battery 26 and the backup power supply 28 based on the instruction of the first CPU 31 and appropriately supply the power to each electric circuit inside the present digital camera.

The battery state detection circuit 29 is a circuit for detecting the state of the battery 26 such as the voltage of the battery 26, calculating the power remaining quantity of the battery 26, and outputting the result thereof to the first CPU 31.

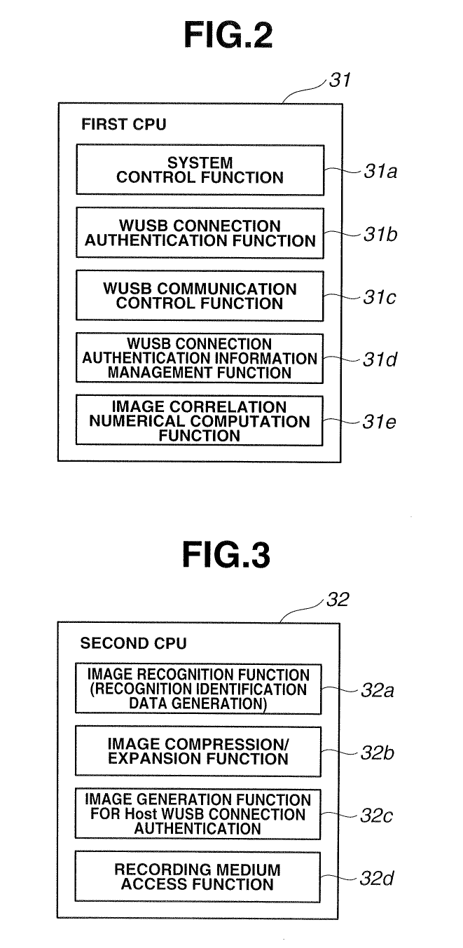

The first CPU 31 is arranged as a main CPU. The first CPU 31 is a control part for centrally controlling each circuit in the digital camera of the present embodiment. For that purpose, the first CPU 31 of the present digital camera includes a system control function part 31 a for appropriately controlling the entire system in the digital camera as shown in FIG. 2.

Further, as shown in FIG. 2, the first CPU 31 is configured to include control function parts for implementing various functions including a function part for performing wireless communication with external apparatuses, such as a WUSB connection authentication function part 31b as a communication information generation part, a WUSB communication control function part 31c as a communication establishment part, a WUSB-connection authentication information management function part 31d as a communication information storage control part, and an image correlation value calculation function part 31e as a similarity calculation part.

The first CPU 31 described above is intended to mainly perform control operations. On the other hand, the second CPU 32 is intended to control various processing to primarily deal with image data.

That is, as shown in FIG. 3, the second CPU 32 is a circuit which receives image data stored in the frame memory 6 and performs various signal processing thereon. The second CPU 32 is configured to include an image recognition function part 32a, an image compression/expansion part 32b as a reduced image generation part, an image generation function for Host WUSB-connection authentication 32c as a list generation part, a recording medium access part 32d as an image recording control part, and the like.

The image compression/expansion part 32b is intended to perform the processing to read out the image data stored in the frame memory 6 and perform, for example, JPEG compression processing thereon, the processing to expand the compressed image data read out from the recording medium 16, and the like.

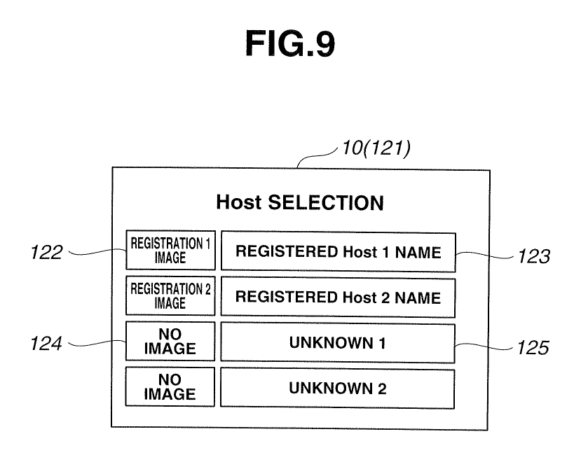

The image generation function for Host WUSB-connection authentication 32c is adapted to generate a Host WUSB-connection authentication image which is a selection list (for example, as later described in FIG. 9) made up of Host photographed image relating to Hosts to which the digital camera can be connected through a WUSB, and equipment specification information for specifying each Host.

The recording medium access part 32d is a circuit part for controlling the access to the recording medium 16 through the recording medium interface 15.

The EEPROM 19 is a non-volatile memory medium, which stores and preserves: a program (firmware) to be executed by the second CPU 32 for controlling each part of the present digital camera; various processing programs (application software); various setting data and specific data in the present digital camera, such as the data of communication setting information to communicate with external apparatuses; and the like, the EEPROM 19 serving as a communication setting memory. For the EEPROM 19, for example, a known flash ROM which is an electrically erasable non-volatile memory or the like is applied.

Moreover, the EEPROM 19 retains data for performing wireless communication individually and selectively for a plurality of external apparatuses (Host) out of preserved data, such as: WUSB authentication information relating to, for example, the communication part to communicate with external apparatuses; and CDID information (Connection Device ID) which is a unique ID number for specifying the digital camera, as the communication setting information 19a, and also retains image recognition identification data 19b associated with the communication setting information.

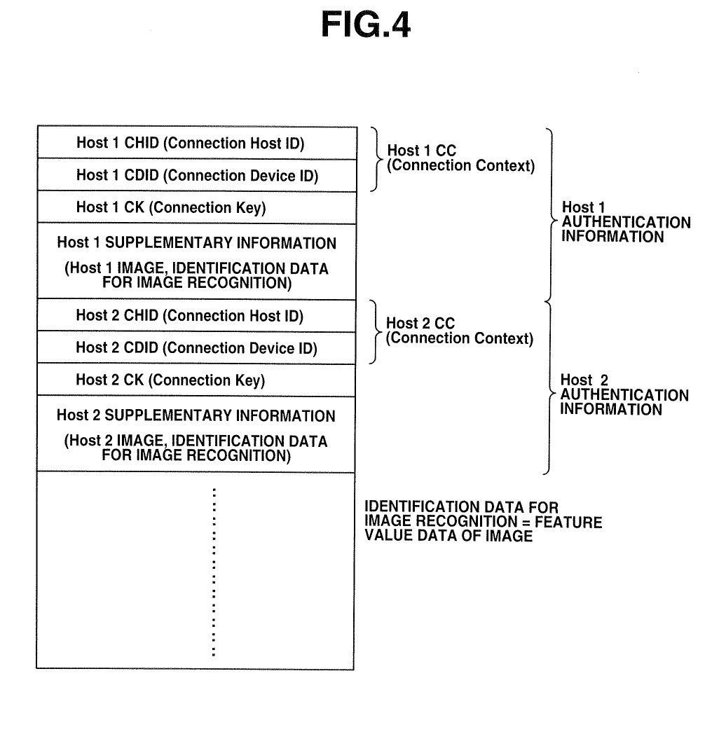

In the EEPROM 19, as shown in FIG. 4, data such as: equipment specification information which includes various information specific to each apparatus, that is, “CC (Connection Context)”; and supplemental information (for example, index image (reduced image data) of image data which photographs the appearance of external apparatuses (Host)) are registered in the form of database in which data is grouped for each external apparatus (Host) with which wireless communication is to be performed, by the communication setting information 19a and the image recognition identification data 19b.

The “CC” includes information such as “CHID (Connection Host ID)”, “CDID (Connection Device ID)”, “CK (Connection Key)”, and the like.

The wireless antenna 21 is an input/output part of wireless signal, which receives a wireless signal such as electromagnetic wave of a predetermined form transmitted from an external apparatus, and transmits a wireless signal such as electromagnetic wave of a predetermined form to be transmitted from the present digital camera, when wireless data communication is performed between the present digital camera and the external apparatus. The wireless antenna 21 is connected to an external wireless data I/F 20 so that a transmitted/received wireless signal is inputted/outputted into and from the external wireless data I/F 20.

The external wireless data I/F 20 is a wireless communication connection part (interface), which is interposed between the wireless antenna 21 and the first CPU 31, and adapted to convert the wireless signal inputted from the wireless antenna 21 into a electrical signal of a predetermined form and output it to the first CPU 31.

Moreover, detailed illustration and description about the configurations of the parts irrelevant to the present invention will be omitted since they are similar to those of ordinary digital cameras.

Next, the effect of the present embodiment having the above described configuration will be described. Although the WUSB authentication processing described below will be explained by way of an example in which authentication is performed through wired USB communication, authentication will not be limited to such a case and of course can be performed through WUSB communication so as to be implemented by other wired/wireless communication protocols such as the known WUSB protocol.

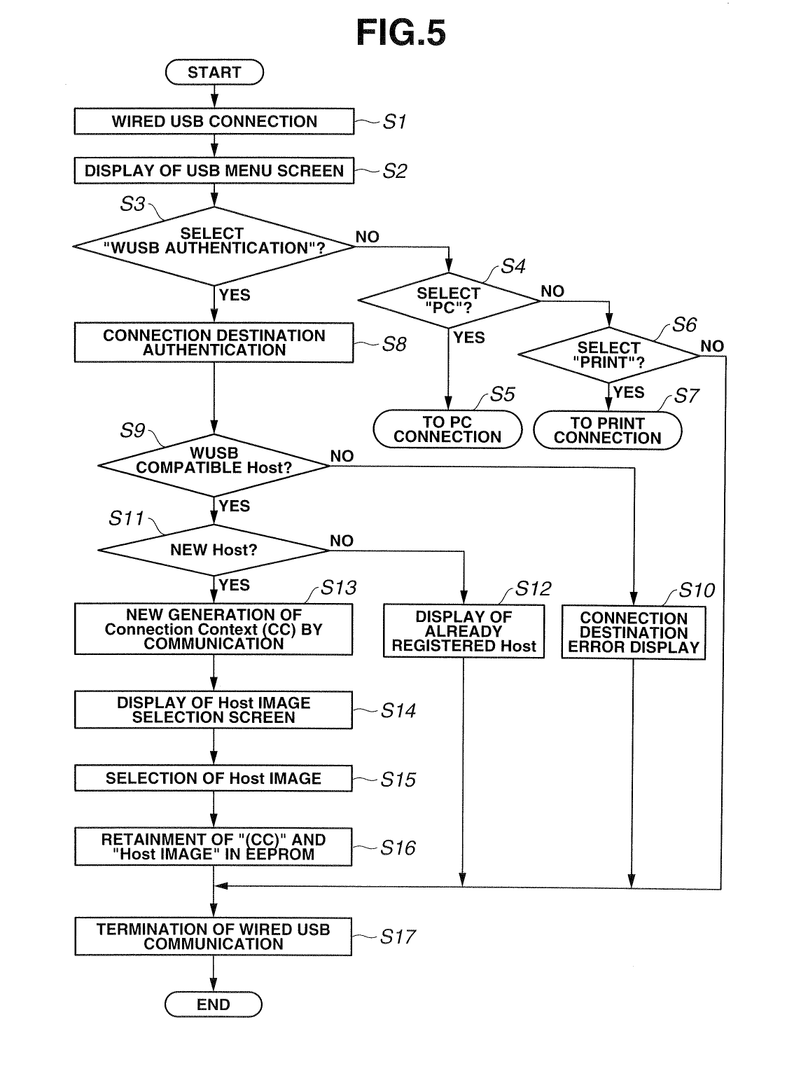

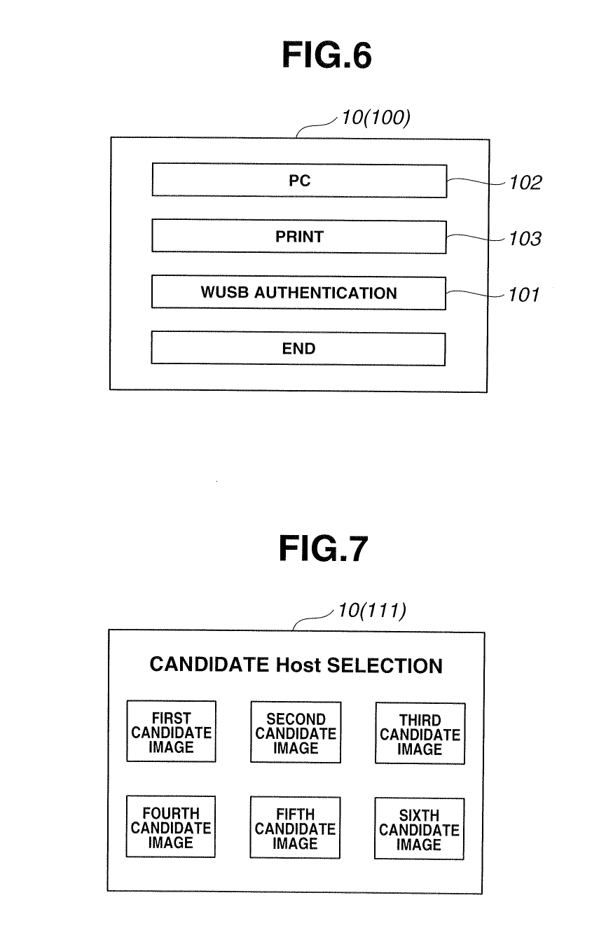

As shown in FIG. 5, when the first CPU 31 detects that the digital camera of the present embodiment is connected by wired USB to an external apparatus via the external wired data I/F 22 at step S1, the first CPU 31 controls the second CPU 32 to cause the TFT panel 10 to display a USB menu screen 100 as shown in FIG. 6 at step S2.

Then, the first CPU 31 detects if the WUSB authentication button 101 on the USB menu screen 100 is selected (by the user) through the key matrix 23 at step S3.

If it is not detected that the WUSB authentication button 101 on the USB menu screen 100 is selected (by the user) through the key matrix 23 at step S3, the first CPU 31 detects if the PC button 102 on the USB menu screen 100 is selected (by the user) through the key matrix 23 at step S4. If it is detected that the PC button 102 is selected, the first CPU 31 establishes communication with the PC (personal computer, not shown), which is an external apparatus, through the wired USB to become connected therewith at step S5.

If it is not detected that PC button 102 on the USB menu screen 100 is selected (by the user) through the key matrix 23 at step S4, the first CPU 31 detects if the printer button 103 on the USB menu screen 100 is selected (by the user) through the key matrix 23 at step S6. If it is detected that the printer button is detected, the first CPU 31 establishes communication with the printer (not shown), which is an external apparatus, through the wired USB to connect therewith at step S7.

When it is detected that the WUSB authentication button 101 on the USB menu screen 100 is selected (by the user) through the key matrix 23 at step S3, the first CPU 31 starts “authentication processing of WUSB connection destination” at step S8.

First, the first CPU 31 determines if the external apparatus currently connected through the USB is a WUSB compatible Host through the communication with the external apparatus at step S9.

If it is determined that the external apparatus currently being connected through wired USB is not a WUSB compatible Host, the first CPU 31 performs connection destination error processing (for example, processing to control the TFT liquid crystal control circuit 9 or the LCD display circuit 24 to perform error notification on the display part of the TFT panel 10 or the LCD panel 25) to end the processing at step S10.

If it is determined that the external apparatus currently being connected through wired USB is a WUSB compatible Host, the first CPU 31 determines if the external apparatus currently being connected through wired USB is a new Host which has been connected for the first time (or for which authentication processing of WUSB has not been performed) at step S11.

If it is determined that the apparatus is not a new Host, the first CPU 31 controls, for example, the TFT liquid crystal drive circuit 9 or the LCD display circuit 24 to perform the display on the TFT panel 10 or the LCD panel 25 to indicate that the Host has already been registered, and ends the processing at step S12.

If it is determined that the apparatus is a new Host, the first CPU 31 newly creates CC (Connection Context) for the new Host through USB (wired) communication at step S13.

Next, the first CPU 31 controls the second CPU 32 to display a plurality of images recorded in the recording medium 16 as a Host image selection screen 111 having thumbnail images of candidate images (first to sixth candidate images in FIG. 7) as shown in FIG. 7, to register an appearance image of a new Host or an image relating to the new Host at step S14.

Then, if the first CPU 31 detects that a candidate image is selected (by the user) through the key matrix 23 at step S15, the processing moves to step S16.

The first CPU 31 retains (preserves) the created CC (Connection Context) and the selected candidate image in the EEPROM 19 at step S16, and terminates (wired) USB communication at step S17 to end the processing.

Thus, in the EEPROM 19 of the digital camera of the present embodiment, CC (Connection Context) of a plurality of Hosts for which WUSB authentication has been performed and selected candidate images are retained as a database.

Next, WUSB communication connection processing between the plurality of Hosts on which WUSB authentication has been performed as describe above and the digital camera will be described.

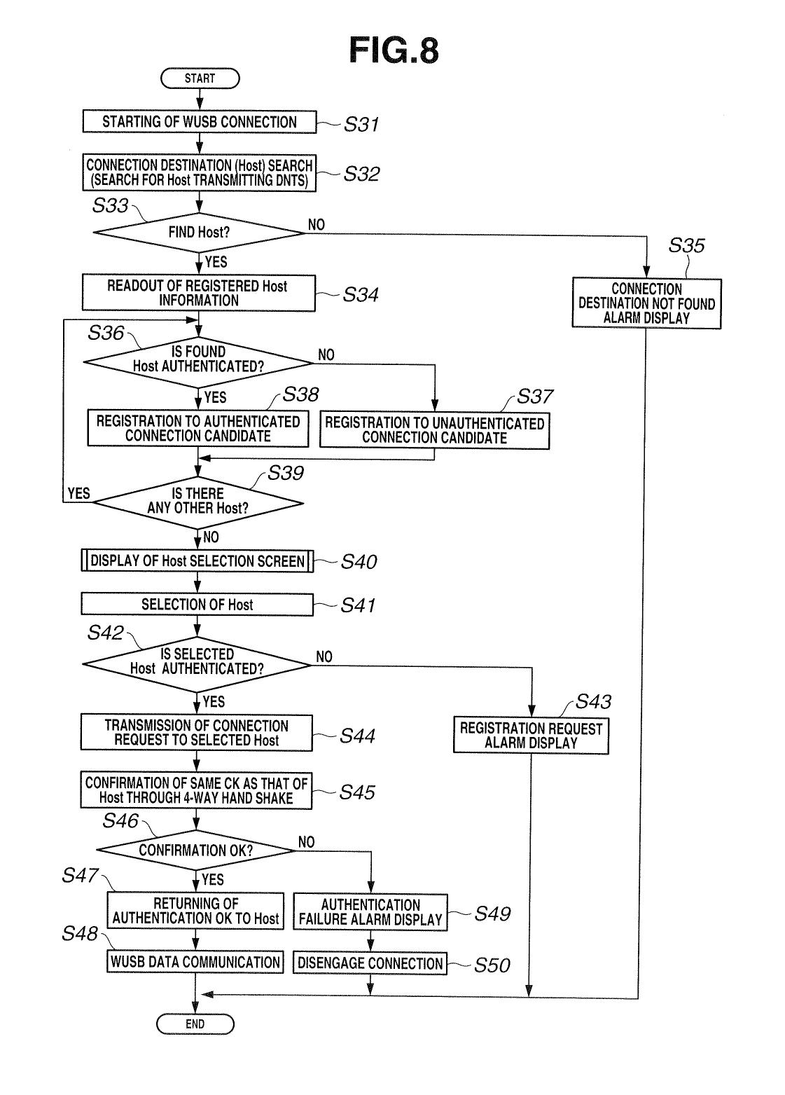

When the digital camera is located in the wireless communication area of a WUSB compatible Host, the first CPU 31 starts WUSB connection processing at step S31 as shown in FIG. 8.

Next, the first CPU 31 performs connection destination search processing to search a Host which is to be the connection destination of the camera at step S32. This connection destination search processing is, for example, the following processing. That is, the first CPU 31 receives a signal inputted from an external wireless data I/F 20 via the wireless antenna 21 to search for the presence or absence of a Host transmitting DNTS (Device Notification Time Slots). Thereafter, the processing moves to next step S33.

At step S33, the first CPU 31 confirms whether or not a Host has been found in the above described connection destination search processing at step S32. If it is determined that a Host has been found, the processing moves to next step S34.

Or, if it is determined that a host has not been found, the first CPU 31 moves on to the processing of step S35.

At step S35, the first CPU 31 performs the processing to display a destination not-found alarm. The connection destination not-found alarm display processing is processing in which, for example, the first CPU 31 controls the TFT liquid crystal drive circuit 9 or the LCD display circuit 24 to perform a predetermined display, that is, an alarm display indicating that connection destination is not found, on the TFT panel 10 or the LCD panel 25. Thereafter, a series of processing is terminated.

When, in the above described step S33, it is determined that a Host is found, and the processing moves to the next step S34, the first CPU 31 performs the processing to read authentication information data from the EEPROM 19 at step S34. Thereafter, the processing moves to a next step S36.

At step S36, the first CPU 31 confirms whether or not the Host found in the above described processing at steps S32 to S33 has been authenticated based on the authentication information data read out by the above described processing at step S34. When it is determined that the Host is not authenticated, the processing moves to step S37.

At step S37, the first CPU 31 performs the processing to register the external apparatus found at the above described steps S32 and S33 as an unauthenticated connection candidate to the authentication information data. Thereafter the processing moves to a next step S39.

On the other hand, in the above described processing at step 37, when it is determined that the Host found in the above described processing at steps S32 and S33 has been authenticated, the first CPU 31 moves to the processing at a next step S38.

At step S38, the first CPU 31 performs the processing to register the Host as a candidate for connection, which has been authenticated. Thereafter, the processing moves to a next step S39.

At step S39, the first CPU 31 confirms whether or not there is any other Host. And if it is determined that there is no other Host, the first CPU 31 moves to the processing at a next step S40.

Moreover, if it is determined that there is another Host, the first CPU 31 returns the processing at the above described step S36 and repeats the processing thereafter.

When, at step S39 described above, it is determined that there is no other Host and the processing moves to step S40, at this step S40, the first CPU 31 performs the processing to cause the display part of the TFT panel 10 to display a host selection screen 121 as shown in FIG. 9 via the TFT liquid crystal drive circuit 9. Thereafter, the processing moves to a next step S41.

The Host selection screen 121 displays combined information made up of a thumbnail of registered images and registration names of the plurality of Hosts, which have been confirmed, so as to be selectable for each Host.

For example, FIG. 9 shows an example in which two Hosts out of the Hosts found have been authenticated and two Hosts have not been authenticated. The authenticated Hosts are displayed by a thumbnail display 122 of registered images and the name display 123 of the Hosts, and the unauthenticated Hosts are displayed by a thumbnail display 124, which indicates that there is no image, and a name display 125 in which the names of the Hosts are denoted as UNKOWN 1, 2 and 3.

At step S41, the user performs the operation to select a Host, which is a desired external apparatus, on the Host selection screen 121 as shown in FIG. 9. The first CPU 31 stands by for a signal generated by the foregoing selection operation. The first CPU 31 confirms the signal generated by the selection operation at step S41, and the processing moves to a next step S42.

At step S42, the first CPU 31 receives an instruction signal generated by the selection operation of the user in the above described processing at step S41, and performs the operation to confirm whether or not the selected Host has been authenticated.

In this case, when the selected Host has been authenticated, the first CPU 31 moves to the processing at a next step S44. On the other hand, when the selected Host has not been authenticated, the first CPU 31 moves to the processing at step S43.

At step S43, the first CPU 31 performs authentication request alarm display processing. The authentication request alarm display processing is a processing in which for example the first CPU 31 controls the TFT liquid crystal drive circuit 9 or the LCD display circuit 24 to perform a predetermined display, that is, an alarm display alarming that authentication is required, on the display part of the TFT panel 10 or the LCD panel 25. Thereafter, a series of processing is terminated.

When, at step S42 describe above, it is confirmed that the selected Host has been authenticated and the processing has moved to step S44, the first CPU 31 performs the processing to control the external wireless data I/F 20 and the wireless antenna 21 to transmit an instruction signal requiring connection with the above described selected Host (the Host selected by the user at the above described step S41) at step S44. Thereafter, the processing moves to a next step S45.

At step S45, the first CPU 31 performs the processing to confirm that it has the same CK (Connection Key) as that of a Host to be connected with, by for example four-way hand shake. Thereafter, the processing moves to a next step S46.

At step S46, determination on the result of confirmation in the confirmation processing at step S31 described above is performed. At this moment, if it is confirmed to have the same CK (Connection Key) as that of the Host, the processing moves to a next step S47.

At step S47, the first CPU 31 performs the processing to transmit a replay indicating that authentication is validated to the Host. Thereafter, the processing moves to a next step S48.

At step S48, the first CPU 31 performs predetermined WUSB data communication processing, and when the WUSB data communication processing is completed, a series of processing is terminated.

On the other hand, at step S46 described above, determination is performed on the result of confirmation items in the confirmation processing at step S45 described above. Here, if it is confirmed not to have same CK (Connection Key) as that of the Host, the processing moves to step S49.

At step S49, the first CPU 31 performs authentication failure alarm display processing. In the authentication failure alarm display processing, for example, the first CPU 31 controls the TFT liquid crystal control circuit 9 or the LCD display circuit 24 to perform a predetermined display, that is, an alarm display alarming that authentication is failed on the display part of the TFT panel or LCD panel 25. Thereafter, the processing moves to step S50.

At step S50, since all the processing is completed, the first CPU 31 performs a connection disengagement processing to disengage the connection state of wireless communication between the digital camera and the external apparatus. Thereafter, a series of processing is terminated.

Thus, since the present embodiment enables the user to select a registered Host by confirming the image of the Host on the Host selection screen 121 (see FIG. 9) on the TFT panel 10 even when the digital camera is located in a wireless area where a plurality of WUSB compatible Hosts are present, an advantageous effect is obtained in that a desired Host can be easily selected from among a plurality of comnection destination Hosts which are connectable, by means of the images of the Hosts.

### Embodiment 2

Since embodiment 2 is almost the same as embodiment 1, description will be made on only different points and the like symbol will be given to the like configuration to omit description thereof.

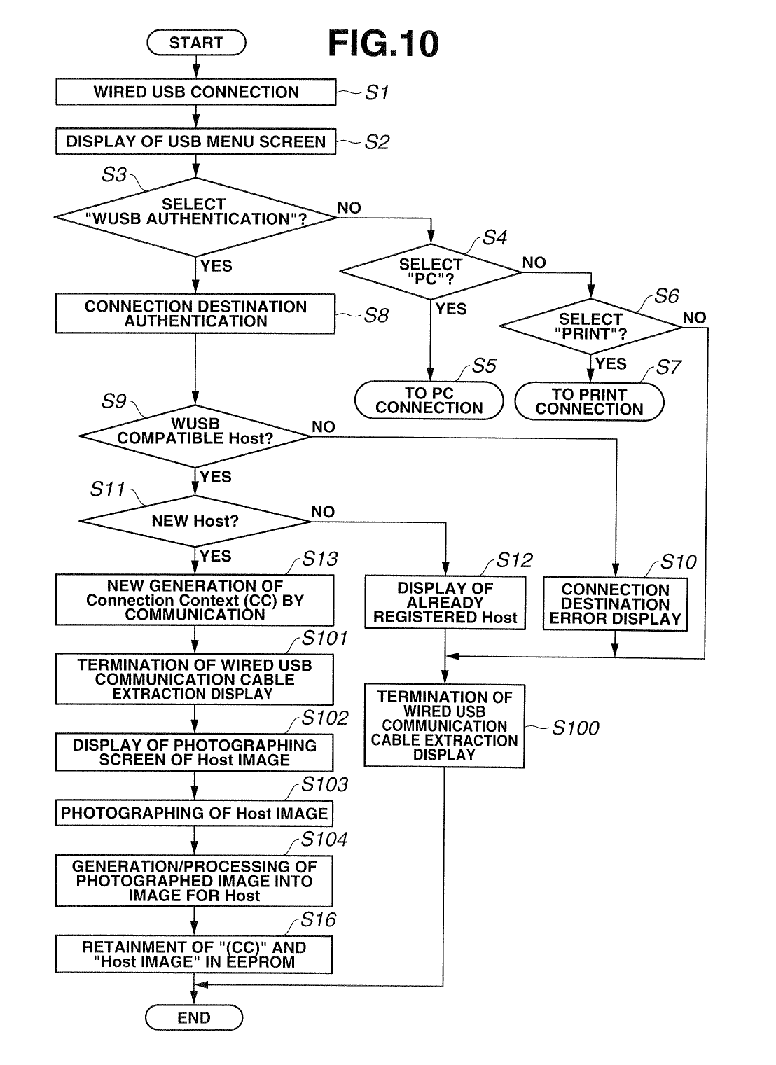

In the present embodiment, as shown in FIG. 10, after the processing of step S10 and step S12 as described in embodiment 1 (see FIG. 5), the first CPU 31 ends wired USB communication and controls the TFT liquid crystal drive circuit 9 or the LCD display circuit 24 to perform a display to instruct the extraction of the USB cable, on the TFT panel 10 or the LCD panel 25 at step S100, thereafter ending the processing.

Further, after the processing of step S13 (see FIG. 5) described in embodiment 1, the first CPU 31 ends wired USB communication and controls the TFT liquid crystal drive circuit 9 or the LCD display circuit 24 to perform a display to instruct the extraction of the USB cable on the TFT panel 10 or the LCD panel 25 at step S101.

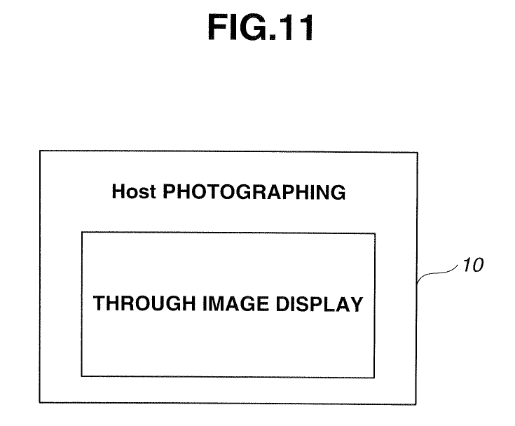

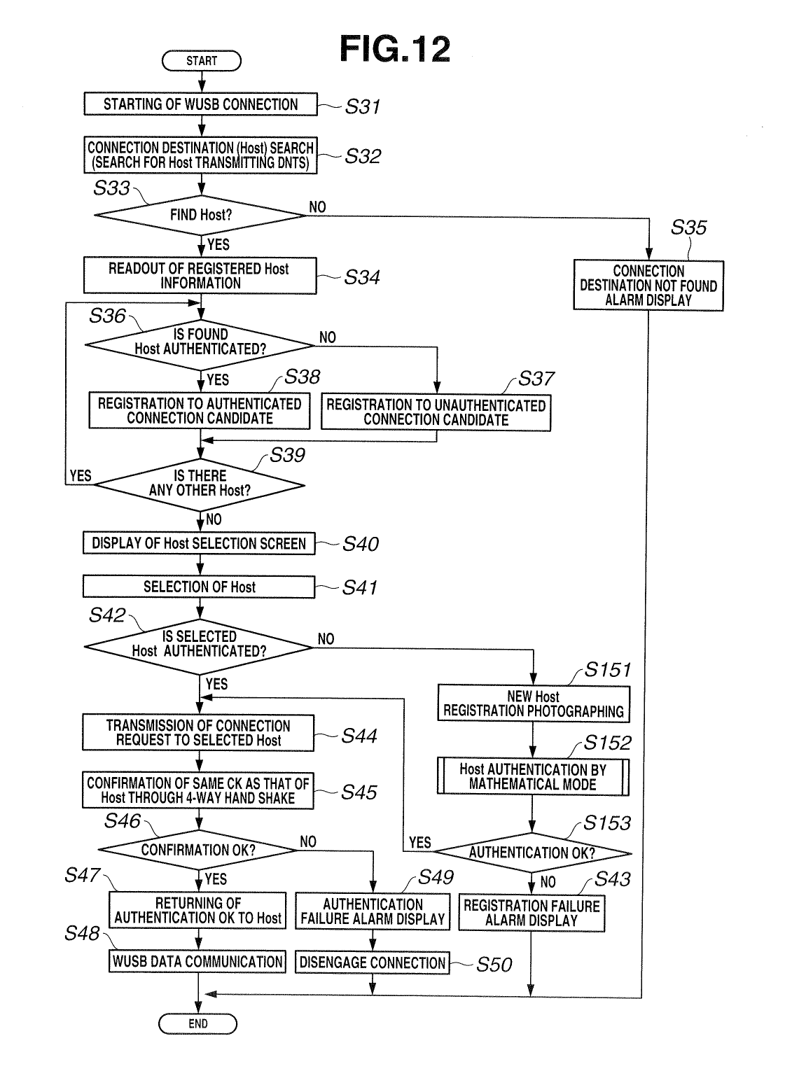

Thereafter, the first CPU 31 controls the second CPU 32 to pick up an image of a new Host to be newly registered with a CCD 2 at step S102. Further, the first CPU 31 controls the TFT liquid crystal drive circuit 9 to display a through image of the new Host on the TFT panel 10 as shown in FIG. 11.

Then, the first CPU 31 controls the second CPU 32 to photograph the image of a new Host to be registered as a static image at step S103. Next, the first CPU 31 controls the second CPU 32 to perform processing such as compression on the photographed static image, thereby performing the generation and processing of Host images at step S104.

Thereafter, the first CPU 31 performs the processing of step S16 described in the embodiment 1, and ends the processing.

Thus, in addition to achieving the effect of embodiment 1, the present embodiment enables not only to use images retained in the EEPROM for the index image for a registered Host (the processing at steps S14 and S15 of embodiment 1) but also to directly photograph a new WUSB compatible Host and use the photographed image as the index image of the registered Host, even when the Host is a new WUSB compatible external apparatus, thereby making it possible to register an optimum index image which is easily associated with CK (Connection Key) of a registered Host.

### Embodiment 3

Since embodiment 3 is almost the same as embodiment 1, description will be made on only different points, and the like symbol will be given to the like configuration to omit description thereof. authenticated in the processing at step S42 described in the embodiment 1 (see FIG. 9), the first CPU 31 controls the second CPU32 at step S151 to photograph the image of a new Host to be registered as a still image. Next, the first CPU 31 performs, at step S52, Host (registration) authentication processing by a mathematical model on the photographed Host image, and at step S153, determines whether or not the (registration) authentication is valid. If the Host (registration) authentication is OK, the processing moves to step S44 described in the embodiment 1, and if the Host (registration) authentication is NG, the processing moves to step S43 described in the embodiment 1.

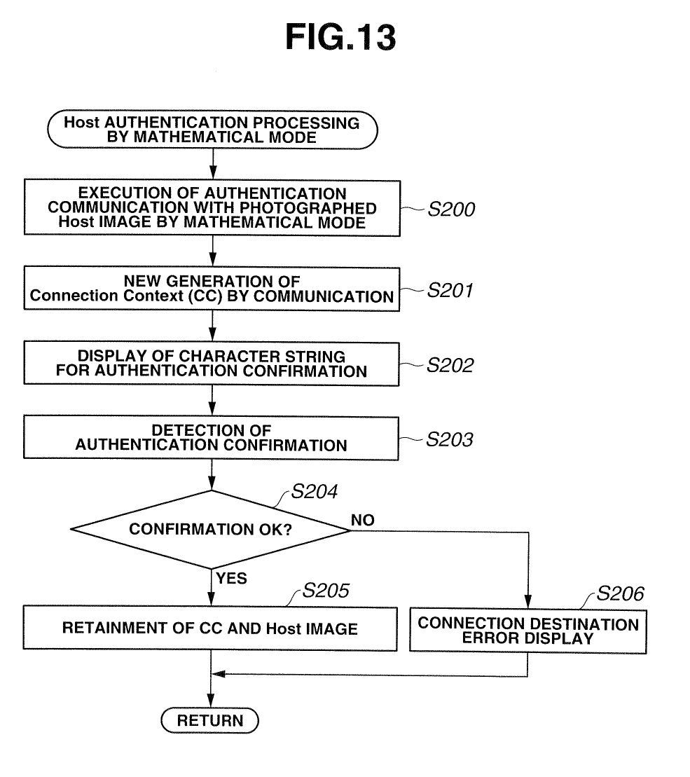

In the Host (registration) authentication processing at the above described step S1 52, as shown in FIG. 13, the first CPU 31 starts authentication communication by a mathematical model with the photographed Host.

The first CPU 31 newly generates CC (Connection Context) of Host through communication with the Host at step S201.

Thereafter, the first CPU 31 displays a character string for authentication confirmation on the TFT panel 10 at step S202. Then, when detecting the confirmation result by the user at step S203, the first CPU 31 determines the confirmation result at step S204.

If the confirmation result is OK, the first CPU 31 associates CC (Connection Context) with the photographed image and retains it in the EEPROM 19 at step S205 to end the processing, and if the confirmation result is No, the first CPU 31 performs the display of connection destination error on the TFT panel 10 at step S205 to end the processing.

Thus, in addition to achieving the effect of the embodiment 1, the present embodiment enables to register the image of an unregistered Host through authentication communication by a mathematical model when an unregistered Host is present during WUSB connection, thereby making it possible to readily associate the Host image with CC (Connection Context) and register the Host image without performing a separate authentication operation over again.

### Embodiment 4

Since embodiment 4 is almost the same as embodiment 1, description will be made on only different points, and the like symbol will be given to the like configuration to omit description thereof.

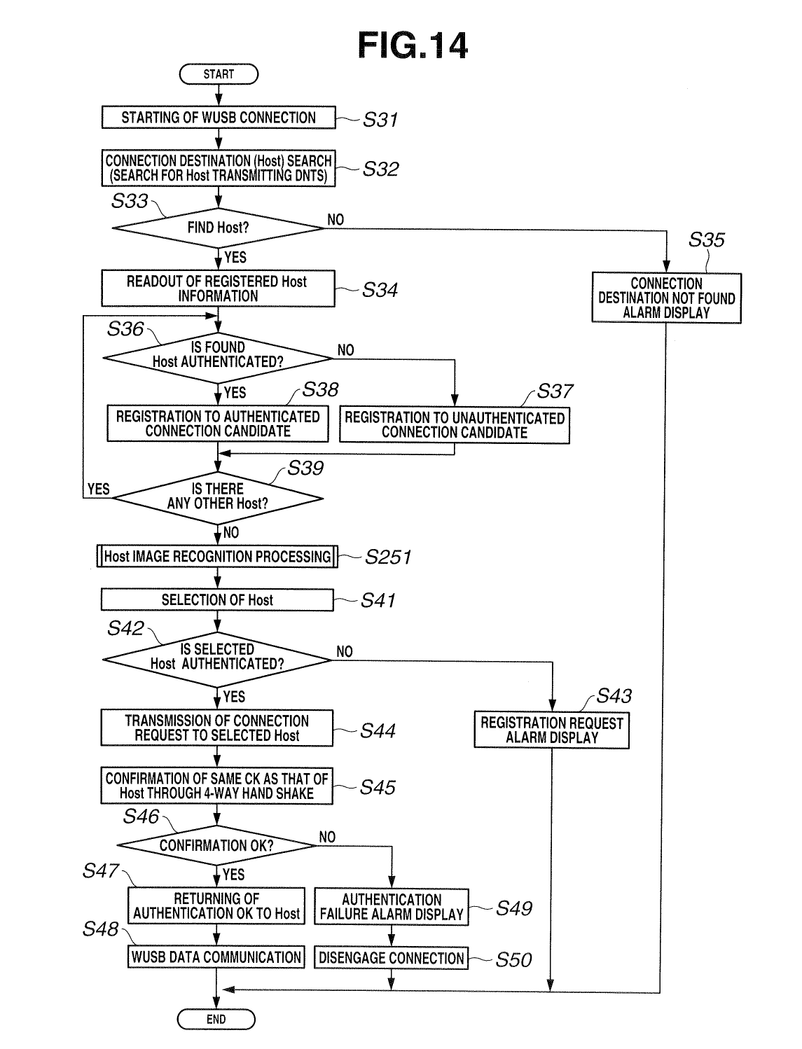

In the present embodiment, as shown in FIG. 14, instead of the processing at step S40 described in the embodiment 1 (see FIG. 8), the Host image recognition processing for the Host desired to be connected at step S251 is performed.

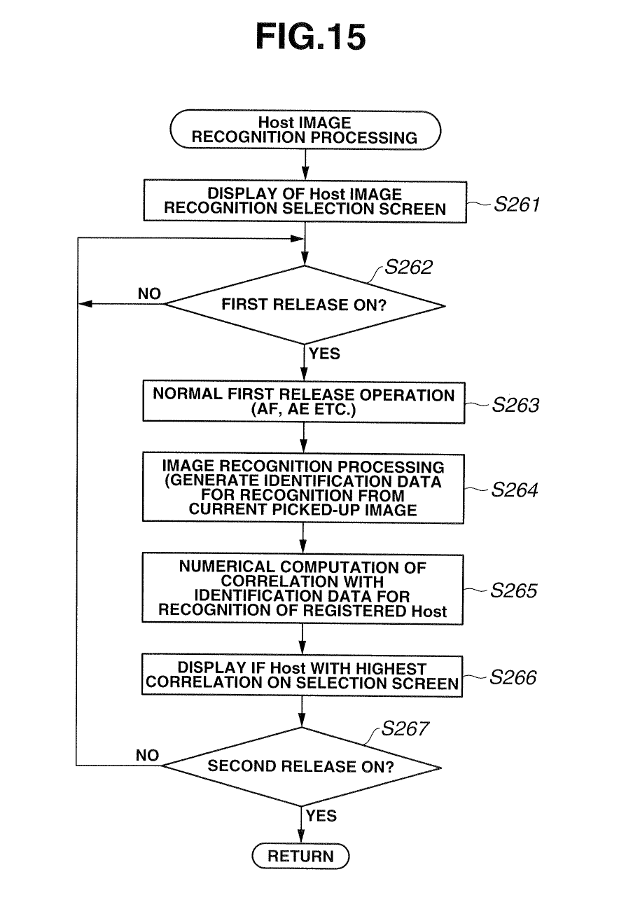

As shown in FIG. 15, in the Host image recognition processing, the first CPU 31 displays a Host image recognition screen (not shown) on the TFT panel 10 at step S261. Then, when detecting that the first release is turned ON at step S262, the first CPU 31 performs a normal first release operation (AF: Auto Focus, AE: Auto Aliasing, etc.) at step S263.

Thereafter, the first CPU 31 starts image recognition processing (the processing to generate recognition identification data based on a predetermined feature value of image from the current picked-up image wanting a connection) at step S264.

Then, the first CPU 31 numerically computes the correlation (similarity) with the identification data for recognition of the registered Host retained in the EEPROM 19 at step S265.

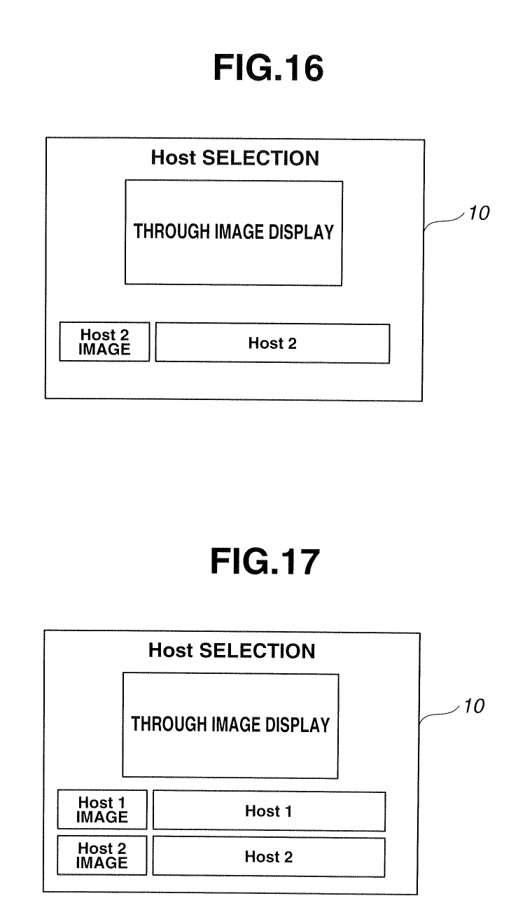

Next, the first CPU 31 displays the information of the registered Host with the highest correlation on the TFT panel 10 as shown in FIG. 16 or FIG. 17 at step S266.

Then, the first CPU 31 ends the processing upon detecting that the second release is turned ON at step S267.

Moreover, FIG. 16 shows the screen on which the information of the registered Host with the highest correlation is displayed, and FIG. 17 shows the screen on which the information of the registered Host with the highest correlation and the information of the registered Host with second highest correlation are displayed so that the user can select either of the Hosts.

Thus, in addition to achieving the effect of the embodiment 1, the present embodiment makes it possible to easily select a Host of connection destination from among a picked-up images of a Host by picking-up a Host selection when WUSB connection starts and calculating the correlation (similarity) between the picked-up image of a Host desired to be connected and the image of a registered Host.

It is clear, in this invention, that a wide variety of different embodiments can be devised based on the present invention without departing from the spirit and scope thereof. Thus, this invention will not be limited to specific embodiments thereof except as limited by the appended claims.

What is claimed is:

1. A digital camera, comprising:
a photographing part for photographing an object;
an image storage control part for performing the control to cause an image memory to store an image photographed at the photographing part as a photographed image;
an information display part for displaying various information including the photographed image on a display;
a communication part for performing the transmission/reception of information to and from an external apparatus by wireless communication;
a communication setting information generation part for generating communication setting information for establishing wireless communication with the external apparatus;
a communication information storage part for storing the communication setting information, equipment specification information for specifying the external apparatus with which the communication part communicates, and an index image of the external apparatus based on the photographed image of the external apparatus so as to be associated with each other, in a communication information memory;
a list generation part for generating a selection list for listing and displaying the index image of the external apparatus stored in the communication information memory, or combined information including the index image of the external apparatus and the equipment specification information of the external apparatus, on the display;
a selection part for selecting an external apparatus, with which the communication part is to establish communication, out of the selection list displayed on the display; and
a communication establishment part for establishing communication with the external apparatus selected at the selection part based on the communication setting information of the external apparatus selected at the selection part.

2. The digital camera according to claim 1, further comprising a reduced image generation part for generating a reduced image by reducing the photographed image photographed by the photographing part or stored in the image memory, wherein
the index image is the photographed image of the reduced image.

3. The digital camera according to claim 2, wherein
the communication information storage part is configured such that:
when the communication setting information generation part generates the communication setting information, the index image is associated with the communication setting information and the equipment specification information to be stored in the communication information memory.

4. The digital camera according to claim 2, wherein
the selection part selects the photographed image stored in the image memory,
the reduced image generation part generates a reduced image by reducing the photographed image selected by the selection part, and
the communication information storage part causes the reduced image selection image as the index image, the communication setting information and the equipment specification information to be associated with each other and stored in the communication information memory.

5. The digital camera according to claim 2, further comprising a similarity calculation part for calculating a similarity between the photographed images and the index image of the external apparatus stored in the image memory, wherein
the list generation part generates the selection list of the index image of the external apparatus stored in the communication information memory based on the similarity calculated by the similarity calculation part, or the combined information including the index image of the external apparatus and the equipment specification information of the external apparatus.

6. The digital camera according to claim 5, wherein
the similarity calculation part calculates the similarity based on a feature value of image.

7. A control method of a digital camera which stores an image obtained by photographing an object in a recording medium, the method comprising:
a communication setting information generation step to generate communication setting information to establish wireless communication with an external apparatus;
a photographed image generation step to generate index image for specifying the external apparatus;
a communication information storage step to store the communication setting information of the external apparatus, equipment specification information to determine the external apparatus, and the index image of the external apparatus so as to be associated with each other;
a list-display step to list and display the index image of the external apparatus stored at the communication information storage step, or combined information including the index image of the external apparatus and the equipment specification information of the external apparatus as a listing on a display of the digital camera;
a selection step to select the index image of the external apparatus to be a communication destination from the listing which is listed and displayed on the display; and
a communication establishment step to establish communication with an external apparatus based on the communication setting information of the external apparatus corresponding to the index image selected at the selection step.

8. The control method of a digital camera according to claim 7, wherein the index image generation step is adapted to generate a reduced image by reducing the photographed image or the image stored in the recording medium.

9. The control method of a digital camera according to claim 7, wherein the list-display step comprises:
a second photographing step to photograph the object; and
a similarity calculation step to calculate the similarity between the image photographed at the second photographing step and the index image of the external apparatus stored in the recording medium, and
the list-display step is adapted to list and display a predetermined number of index images of the external apparatus from the one with the largest similarity, or the combined information including the index image of the external apparatus and the equipment specification information.

10. The control method of a digital camera according to claim 9, wherein the list-display step comprises:
a second photographing step to photograph the object; and
a similarity calculation step to calculate the similarity between the image photographed at the second photographing step and the index image of the external apparatus stored in the recording medium, and
the list-display step is adapted to list and display a predetermined number of index images of the external apparatus from the one with the largest similarity, or the combined information including the index image of the external apparatus and the equipment specification information.
